(19) United States
(12) Patent Application Publication
(10) Pub. No.: US 2013/0014558 A1
(43) Pub. Date: Jan. 17, 2013

(54) SHOCK AND IMPACT TESTING DEVICE AND METHOD

(71) Applicants: DI-GANG ZHAI, Shenzhen City (CN); GUANG-MING WEN, Shenzhen City (CN); YUAN-WANG LIU, Shenzhen City (CN)

(72) Inventors: DI-GANG ZHAI, Shenzhen City (CN); GUANG-MING WEN, Shenzhen City (CN); YUAN-WANG LIU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/298,403

(22) Filed: Nov. 17, 2011

(30) Foreign Application Priority Data
Jul. 13, 2011 (CN) 201110195460.0

(51) Int. Cl. G01N 3/30

(52) U.S. Cl. 73/12.01

(57) ABSTRACT

A shock and impact testing device includes a shock and impact module and a control module. The shock and impact module includes a base, a platform, an elastic cushion positioned on the base, an elastic impact pad positioned on the platform facing the cushion, and a lifting structure connected to the platform to drive the platform to rise and then release the platform to allow the platform to fall down until the impact pad hits the cushion. The control module includes an interface configured for inputting impact parameters, a converting unit and a control unit. The converting unit calculates corresponding testing parameters according to the impact parameters. The control module controls the lifting structure to drive the platform to rise according to the testing parameters.

### BACKGROUND

1. Technical Field

The disclosure generally relates to shock and impact testing devices and methods, and particularly to a shock and impact testing device and method for electronic devices such as mobile phones.

2. Description of Related Art

During the manufacture of electronic devices such as mobile phones, shock and impact testing is commonly executed to verify assembly qualities of the electronic devices. A typical shock and impact testing device includes a platform, an impact pad, a cushion and a lifting structure. The platform is configured for supporting the electronic device. The impact pad and the cushion are elastic. The impact pad is positioned on one side of the platform, opposite to the cushion. The lifting structure drives the platform to rise to a height and then release the platform. The platform falls downwards until the impact pad hits the cushion to simulate a shock and impact situation to test the electronic device.

During testing, a suitable height difference between the impact pad and the cushion is needed to obtain corresponding impact parameters such as a falling acceleration of the platform and a staying time of the impact pad for the electronic devices.

Operators commonly select a height difference according to experience, then drive the shock and impact testing device to execute the testing steps to check whether predetermined testing parameters could be obtained, and repeat the aforesaid steps until predetermined testing parameters is obtained. Thus, much time may be wasted during test and the lifetime of the shock and impact testing device may be shortened because of the repeated impact process.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the disclosure.

FIG. 1 is a schematic view of a shock and impact module of a shock and impact device, according to an exemplary embodiment of the disclosure.

FIG. 2 is a block diagram of a control module of a shock and impact device, according to an exemplary embodiment of the disclosure.

### DETAILED DESCRIPTION

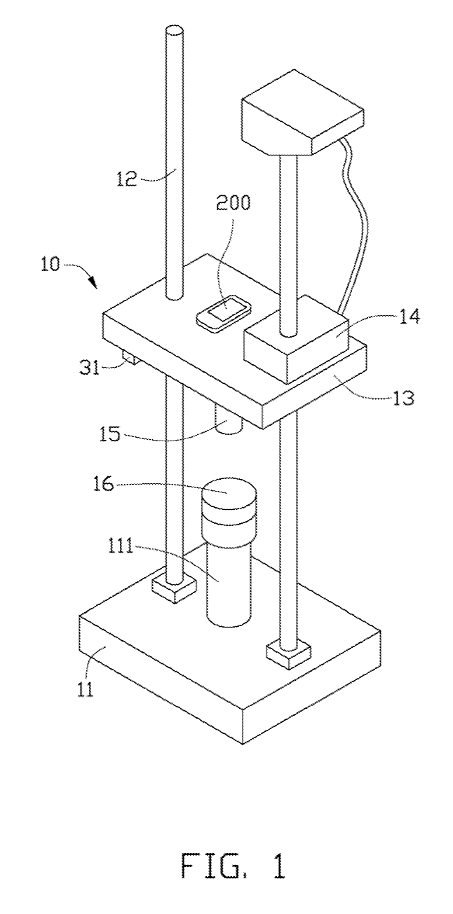

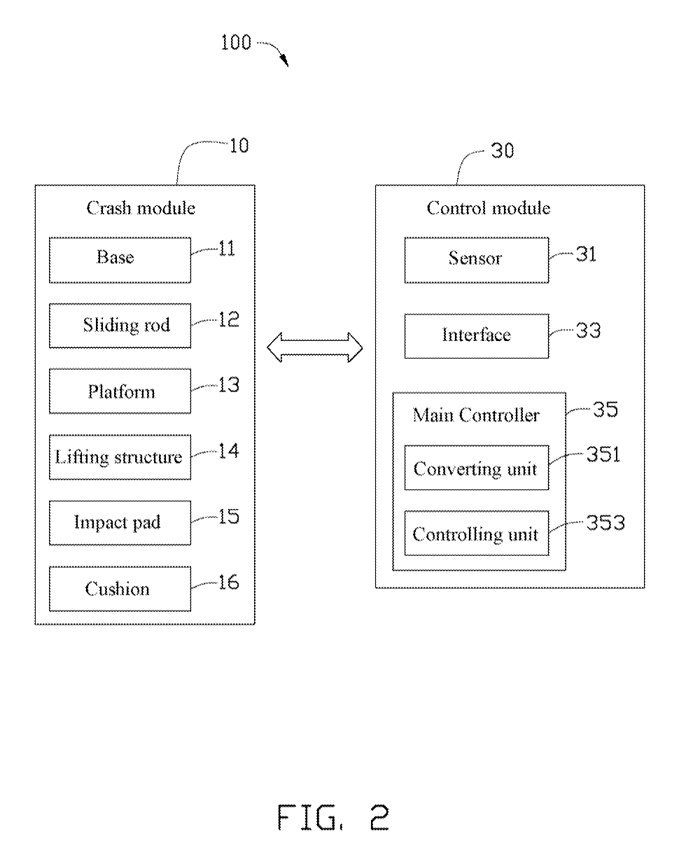

Referring to FIGS. 1 and 2, an exemplary embodiment of shock and impact testing device 100 includes a shock and impact module 10 and a control module 30 electrically connected to the shock and impact module 10. The shock and impact testing device 100 is used to execute shock and impact testing for an electronic device 200.

The shock and impact module 10 includes a base 11, a plurality of sliding rods 12, a platform 13, a lifting structure 14 (schematically shown), an impact pad 15, and a cushion 16. A securing block 111 is positioned on the base 11 to securely position the cushion 16. In this embodiment, there are two sliding rods 12, the two sliding rods 12 are parallel to each other and perpendicularly arranged on the base 11. The platform 13 is configured for supporting the electronic device 200. The sliding rods 12 extend through the platform 13, thus the platform 13 can slide along the sliding rods 12 to be close to or spaced from the base 11. The lifting structure 14 is secured to the platform 13 for driving the platform 13 to rise or fall along the sliding rods 12. The impact pad 15 and the cushion 16 are elastic. The impact pad 15 is positioned on one side of the platform 13 facing the cushion 16. The cushion 16 is positioned on the securing block 111, and is aligned with the impact pad 15.

When the lifting structure 14 drives the platform 13 to rise to a preset height (i.e. a height difference between the impact pad 15 and the cushion 16), and then releases the platform 13, the platform 13 falls downwards along the sliding rods 12 until the impact pad 15 hits the cushion 16. The cushion 16 is compressed by the impact pad 15. The impact pad 15 stays on the cushion 16 for a period of time, defined as staying time D, and then rebounds back from the cushion 16.

The control module 30 includes a sensor 31, an interface 33 and a main controller 35. In this embodiment, the sensor 31 is positioned on one side of the platform 13 facing the base 11. The sensor 31 measures a falling acceleration (A) of the platform 13 and a compressed shift (u) of the cushion 16 when the impact pad 15 hits the cushion 16. In another embodiment, the sensor 31 may be positioned on the securing block 111 and sends the measured falling acceleration and compressed shift to the main controller 35. The interface 33 is configured for inputting impact parameters, such as the falling acceleration A and the staying time D.

The main controller 35 includes a converting unit 351 and a controlling unit 353 connecting to the converting unit 351. The converting unit 351 is configured for receiving the input impact parameters, and computing corresponding testing parameters to be set in the shock and impact module 10 such as the height difference H between the impact pad 15 and the cushion 16, according to the impact parameters. The control module 353 is configured for control the lifting structure 14 to drive the platform 13 to move according to the testing parameters.

A method of computing the height difference H between the impact pad 15 and the cushion 16 by the converting unit 351 may be illuminated as follow:

A first formula: MA+F(u)=0 can be obtained, according to Newtonian second law, wherein M is a total weight of the platform 13, the lifting structure 14 and the impact pad 15, and is a fixed value; A is the falling acceleration of the platform 13 after the impact pad 15 hits to the cushion 16, which can be measured by the sensor 31; F(u) is an elastic restoring force of the cushion 16.

In addition, the elastic restoring force F(u) of the cushion 16 can be obtained through a second formula: F(u)=ku+βu³. Wherein, k is a linear restoring force coefficient, ku is a linear restoring force, β is a nonlinear restoring force coefficient, βu³ is a nonlinear restoring force. The compressed shift u of the cushion 16 can be measured by the sensor 31.

Thus, a third formula: MA+ku+βu³=0 can be obtained through combining the first and second formulas.

A derivative u′/_{D=0}=−\sqrt{2 gH} of the compressed shift u with respect to D can be obtained according to the third formula, which represents that when the staying time D=0, an initial speed of the cushion 16 is equal to −\sqrt{2 gH}.

When the height differences of the impact pad 15 and the cushion 16 are H1 and H2, a first group of falling acceleration A1 and compressed shift u1 and a second group of falling acceleration A2 and compressed shift u2 can be respectively measured through the sensor 31. A corresponding equation group: M×A₁=−(κ×u₁+β×u₁³) and M×A₂=−(κ×u₂+β×u₂³) can be obtained by inputting the first and second groups of measured values to the third formula: MA+ku+βu³=0. The linear restoring force coefficient k and the nonlinear restoring force coefficient β can be calculated according to the above formula groups.

Therefore, through inputting the linear restoring force coefficient k and the nonlinear restoring force coefficient β to the third formula and combining equation: u′/_{D=0}=−\sqrt{2 gH}, a function of the falling acceleration A and the staying time D can be simulated by software such as Matlab when the height difference H is other values. In this embodiment, the function of the falling acceleration A and the staying time D is a sine function. In addition, relationships of the falling accelerations A, the staying times D and the height differences H are stored in the converting unit 351 to facilitate the calculating process. In another embodiment, the impact pad 15 and the cushion 16 may have other different heights, thus the converting module 351 can store the relationships of the falling accelerations A, the staying times D and the height differences H corresponding to different combination means of the impact pad 15 and the cushion 16.

When the impact parameters (e.g. a falling acceleration of A=60 G and a staying time of D=11 ms) are input into the converting unit 351 through the interface 33, the converting unit 351 calculates a corresponding testing parameter of the shock and impact module 10 (i.e. a height difference between the impact pad 15 and the cushion 16) according to the stored relationships of the falling accelerations A, the staying times D and the height differences H. Thus, the suitable parameter can be obtained without executing the crash process for many times, which can save the testing time and decrease crash times of the shock and impact module 10.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A shock and impact testing device comprising:
a shock and impact module, the shock and impact module comprising:
a base;
a platform;
an elastic cushion positioned on the base;
an elastic impact pad positioned on the platform facing the cushion; and
a lifting structure connected to the platform to drive the platform to rise and then release the platform to allow the platform to fall down until the impact pad hits the cushion; and
a control module, the control module comprising:
an interface configured for inputting impact parameters;
a converting unit calculating corresponding testing parameters according to the impact parameters; and
a control module controlling the lifting structure to drive the platform to rise according to the testing parameters.

2. The shock and impact testing device of claim 1, wherein the impact parameters comprises a falling acceleration of the platform and the amount of time the impact pad stays on the cushion, the testing parameters comprises a height difference between the impact pad and cushion.

3. The shock and impact testing device of claim 2, wherein the lifting structure drives the platform to rise by the height difference calculated by the converting unit.

4. The shock and impact testing device of claim 1, wherein the shock and impact module further comprises two sliding rods perpendicularly position on the base and extends through the platform.

5. The shock and impact testing device of claim 2, wherein the shock and impact module further comprises a sensor, the sensor measures the falling acceleration of the platform and a compressed shift of the cushion, and sends the measured falling acceleration and compressed shift to the converting unit.

6. A shock and impact testing method comprising:
providing a shock and impact module, the shock and impact module comprising:
a base;
a platform;
an elastic cushion positioned on the base;
an elastic impact pad positioned on the platform facing the cushion; and
a lifting structure connected to the platform to drive the platform to rise and then release the platform to allow the platform to fall down until the impact pad hits the cushion;
inputting impact parameters;
calculating corresponding testing parameters according to the input impact parameters;
controlling the lifting structure to drive the platform to rise according to the testing parameters.

7. The shock and impact testing method of claim 6, wherein the impact parameters comprises a falling acceleration of the platform and the amount of time the impact pad stays on the cushion, the testing parameters comprises a height difference between the impact pad and cushion.

8. The shock and impact testing method of claim 7, wherein the height difference between the impact pad and cushion is calculated according to formulas: MA+ku+βu³=0 and u′/_{D=0}=−\sqrt{2 gH}, wherein M is a total weight of the platform, the lifting structure and the impact pad, A is the falling acceleration; k is a linear restoring force coefficient; ku is a linear restoring force, β is a nonlinear restoring force coefficient, βu³ is a nonlinear restoring force.

9. The shock and impact testing device of claim 7, wherein the lifting structure drives the platform to rise by the height difference calculated by the converting unit.

10. A control module in electronic communication with a shock and impact module, wherein the shock and impact module comprises a base, a platform, an elastic cushion positioned on the base, an elastic impact pad positioned on the platform facing the cushion; and a lifting structure connected to the platform to drive the platform to rise and then release the platform to allow the platform to fall down until the impact pad hits the cushion; remote monitoring apparatus, wherein the control module comprising:
an interface configured for inputting impact parameters;
a converting unit calculating corresponding testing parameters according to the impact parameters; and
a control module controlling the lifting structure to drive the platform to rise according to the testing parameters.

11. The control module of claim 10, wherein the impact parameters comprises a falling acceleration of the platform and the amount of time the impact pad stays on the cushion, the testing parameters comprises a height difference between the impact pad and cushion.

12. The control module of claim 11, wherein the lifting structure drives the platform to rise by the height difference calculated by the converting unit.

13. The control module of claim 10, wherein the shock and impact module further comprises two sliding rods perpendicularly position on the base and extends through the platform.

14. The control module of claim 11, wherein the shock and impact module further comprises a sensor, the sensor measures the falling acceleration of the platform and a compressed shift of the cushion, and sends the measured falling acceleration and compressed shift to the converting unit.
